(19) United States
(12) Patent Application Publication
(10) Pub. No.: US 2014/0216906 A1
(43) Pub. Date: Aug. 7, 2014

(54) KEY STRUCTURE

(71) Applicants: Wen-Yuan Lin, Taipei City (TW); Ya-Chun Tu, Taipei City (TW)

(72) Inventors: Wen-Yuan Lin, Taipei City (TW); Ya-Chun Tu, Taipei City (TW)

(73) Assignee: ASUSTeK COMPUTER INC., Taipei City (TW)

(21) Appl. No.: 14/141,476

(22) Filed: Dec. 27, 2013

(30) Foreign Application Priority Data
Feb. 4, 2013 (CN) 201310044688.9

(51) Int. Cl. H01H 3/12

(52) U.S. Cl. CPC H01H 3/122
USPC 200/344

(57) ABSTRACT

A key structure including a bottom portion, a keycap, an elastic element and a positioning unit is provided. The keycap includes a plurality of fixing portions. The elastic element is configured between the bottom portion and the keycap. The positioning unit is fixed on the bottom portion and is assembled with the fixing portions. The keycap moves relative to the bottom portion via the positioning unit.

### CROSS-REFERENCE TO RELATED APPLICATION

This application claims the priority benefit of China application serial No. 201310044688.9, filed on Feb. 4, 2013. The entirety of the above-mentioned patent application is hereby incorporated by reference herein and made a part of specification.

### BACKGROUND OF THE INVENTION

1. Field of the Invention

The invention relates to a key structure and, more particularly, to a key structure including a positioning unit.

2. Description of the Related Art

A keyboard usually couples to an electronic device (such as a notebook) for users to input data in the notebook.

Conventional keyboards are generally divided into a contact-type keyboard and a contactless-type keyboard. The most common contact-type keyboard is a mechanical keyboard and a membrane keyboard. The most common contactless-type keyboard is a capacitive keyboard.

The capacitive contactless-type keyboard generates a corresponding electronic signal by sensing the variation of the capacitance. The contact-type keyboard moves vertically via a bridge structure (a scissor structure) to make elements contact to transmit an electronic signal of the keyboard.

However, the key structure of the contact-type keyboard is complicated, which causes inconvenience and difficulty in assembly.

Additionally, in order to operate when the ambient lighting is insufficient, several light-emitting diodes (LEDs) are disposed under the keyboard to illuminate the key structure. However, a bridge structure of the key structure often blocks the light from the light-emitting diodes (LEDs).

### BRIEF SUMMARY OF THE INVENTION

A key structure which is convenient to assemble and can move vertically in a smooth and stable way is provided.

A key structure including a bottom portion, a keycap, an elastic element and a positioning unit is provided. The keycap includes a plurality of fixing portions. The elastic element is configured between the bottom portion and the keycap. The positioning unit is fixed on the bottom portion and assembled with the fixing portions. The keycap moves relative to the bottom portion via the positioning unit.

In the key structure, the fixing portions are assembled with the positioning unit, and the keycap moves relative to the bottom portion via the positioning unit. When the keycap is pressed to make the keycap move towards the bottom portion, the keycap moves along the positioning unit towards the bottom portion without deviation. On the contrary, when an external force pressing the keycap is released, the elastic element can make the keycap leave away from the bottom portion via its elastic force, and the keycap still moves along the positioning unit towards the bottom portion without deviation. Thus, the key structure is smooth and stable in the vertically moving process via the positioning unit.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a key structure in the first embodiment;

FIG. 2A is a side view showing a key structure shown in FIG. 1 before pressed in the first embodiment;

FIG. 2B is a side view showing a key structure shown in FIG. 1 after pressed in the first embodiment;

FIG. 3 is a schematic diagram showing a key structure in the second embodiment;

FIG. 4A to FIG. 4D are flow charts showing the process of manufacturing a key structure shown in FIG. 1 in the first embodiment;

FIG. 5A is a side view showing a key structure before pressed in the second embodiment; and

FIG. 5B is a side view showing a key structure after pressed in the second embodiment.

### DETAILED DESCRIPTION OF THE EMBODIMENTS

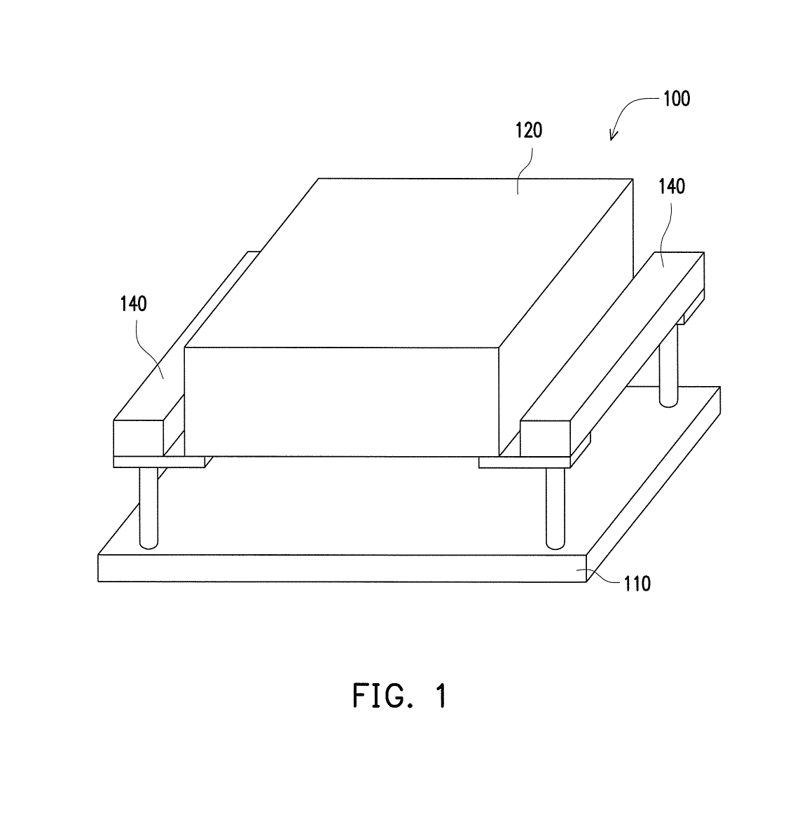

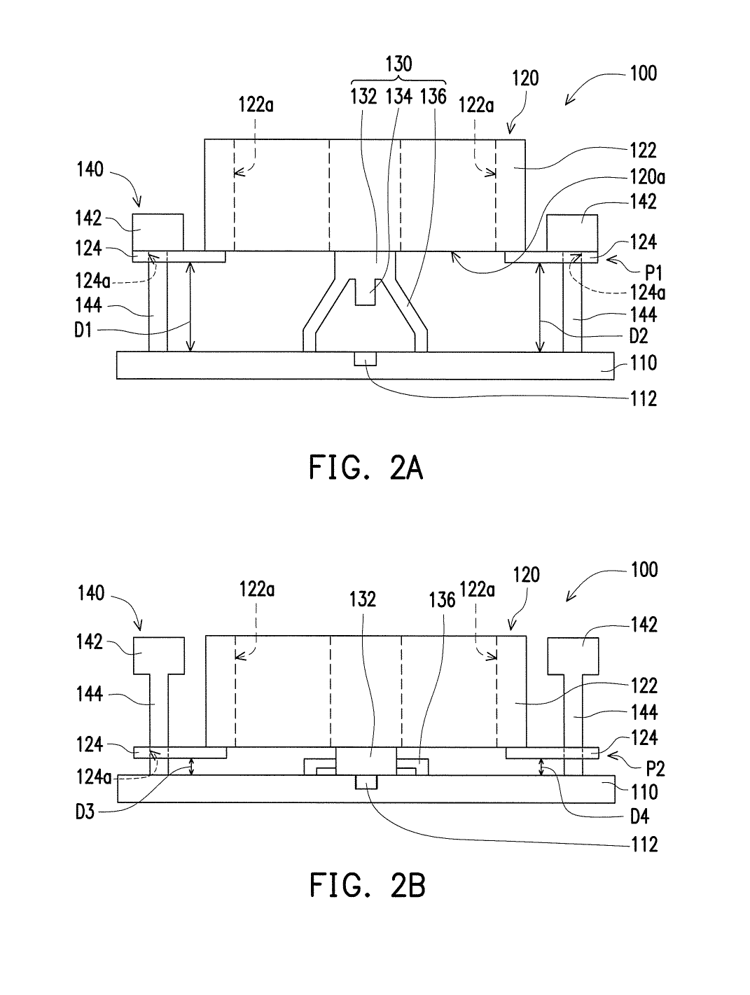

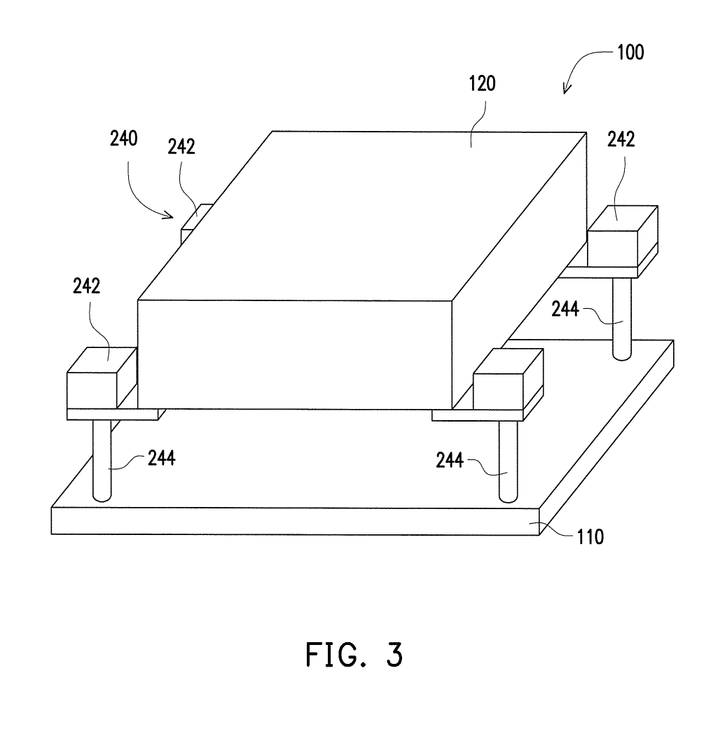

FIG. 1 is a schematic diagram showing a key structure in the first embodiment. FIG. 2A is a side view showing a key structure shown in FIG. 1 before pressed and FIG. 2B is a side view showing a key structure shown in FIG. 1 after pressed. FIG. 3 is a schematic diagram showing a key structure in the second embodiment. Please refer to FIG. 1, FIG. 2A, FIG. 2B and FIG. 3, a key structure 100, such as a key of a membrane keyboard, includes a bottom portion 110, a keycap 120, an elastic elements 130 and a positioning unit 140. The bottom portion 110 includes a press unit 112, such as a membrane switch or other trigger switches. The bottom portion 110 includes a metal plate and a flexible circuit board, which is not limited herein.

The keycap 120 includes a plurality of fixing portions 124a. The elastic element 130 is configured between the bottom portion 110 and keycap 120. The positioning unit 140 is fixed on the bottom portion 110 and assembled with the fixing portions 124a. The keycap 120 moves relative to the bottom portion 110 via the positioning unit 140.

In this configuration, the fixing portions 124a are assembled with the positioning unit 140 and the keycap 120 moves relative to the bottom portion 110 via the positioning unit 140. When the keycap 120 is pressed to make the keycap 120 move from an original position P1 as shown in FIG. 2A towards a contact position P2 as shown in FIG. 2B, the keycap 120 moves along the positioning unit 140 towards bottom portion 110 without deviation. The elastic element 130 is deformed and contacts the bottom portion 110 to trigger the key structure 100. On the contrary, when no external force is pressed on the keycap 120, the elastic element 130 can make the keycap 120 move from the contact position P2 as shown in FIG. 2B towards the original position P1 as shown in FIG. 2A via its elastic force for continuing to input data. And the keycap 120 still move along the positioning unit 140 without deviation. Thus, the key structure 100 is smooth and stable in the vertically moving process via the positioning unit 140.

The keycap 120 includes a body 122 and a plurality of side portions 124. The side portions 124 are located around the body 122, and the fixing portions 124a are respectively located at the side portions 124. In the embodiment, the shape of the side portions 124 is a rectangle, and the number of the side portions 124 is four, which is not limited herein, they can be changed according to actual requirements.

Additionally, the positioning unit 140 includes one or more positioning portions 142 which are located above the side portions 124. The positioning portions 142 are corresponding to the fixing portions 124a respectively. Referring to FIG. 1, the number of the positioning portions 142 is two, and each positioning portion includes two corresponding positioning pillars 144, that is, the number of the positioning pillars 144 is four. The side portions 124 are movably set on the positioning pillars 144 to make the body 122 move relative to the bottom portion 110.

The shape and the number of the positioning portions 142 can be adjusted according to an actual key structure 100, which is not limited herein. Referring to FIG. 3, the number of the positioning portions 242 of the positioning unit 240 is four and each positioning portion 242 corresponds to a positioning pillar 244. Because of the angle of view in FIG. 3, only three positioning pillars are shown, and the other one is blocked by the keycap 120.

In detail, please refer to FIG. 2A, the fixing portions 124a are located at the side portions 124. The fixing portion 124a may be a positioning hole, the way of assembling the fixing portion 124a and the positioning unit 140 is not limited herein. The positioning pillars 144 pass through the fixing portions 124a to make the side portions 124 move along positioning pillars 144 relative to the bottom portion 110.

Additionally, please refer to FIG. 1 to FIG. 2A, as the four positioning pillars 144 are set around the body 122 of the keycap 120, when the keycap 120 moves relative to the bottom portion 110, the distance between each side portion 124 and the bottom portion 110 is the same. Referring to the original position P1 as shown in FIG. 2A, distances between the side portions 124 and the bottom portion 110 are respectively a first distance D1 and a second distance D2, and the first distance D1 is equal to the second distance D2, so the height of the two side portions 124 of the keycap 120 are the same, which would not make the body 122 deviate. Because of the angle of view in FIG. 2A, only two positioning pillars 144 are shown, and the other two are blocked by the positioning pillars 144 shown in FIG. 2A.

On the contrary, when the keycap 120 is pressed to make the keycap 120 move from the original position P1 as shown in FIG. 2A towards the contact position P2 as shown in FIG. 2B, side portions 124 of the keycap 120 move along the positioning pillars 144, which would not make the body 122 deviate, wherein distances between the positioning portions 142 and the bottom portion 110 are respectively a third distance D3 and a fourth distance D4, and the third distance D3 is equal to the fourth distance D4.

As a result, the key structure 100 is smooth and stable when it moves up and down via the positioning pillars 144 of the positioning unit 140. In the embodiment, the number of the positioning pillars 144 is four, and they are respectively configured at four corners of the body 122, which is not limited herein. In other embodiments, the number of the positioning pillars 144 may be more than four, which is not limited herein.

The elastic element 130 includes a connecting portion 132, a conducting portion 134 and a pair of support legs 136. The connecting portion 132 is connected to the back surface 120a of the keycap 120.

The conducting portion 134 is located between the support legs 136. Additionally, the conducting portion 134 is configured at the back surface 120a of the keycap 120 corresponding to the press unit 112. When the keycap 120 moves relative to the bottom portion 110, the connecting portion 132 moves towards the bottom portion 110 to make the support legs pressed and deformed, and then the conducting portion 134 contacts the press unit 122 to execute a function of inputting.

Additionally, the key structure 100 also may be a key of an illuminant keyboard. An illuminant module (not shown) is set under the key of the illuminant keyboard. The body 122 includes a light-transmitting area 122a. The light-transmitting area 122a is located at an upper or side surface of the keycap 120. In the embodiment, instead of a conventional bridge structure, the positioning unit 140 is used to make the key structure 100 smooth and stable in the process of moving up and down, and the positioning unit 140 is not configured between the body 122 and bottom portion 110, and thus the positioning unit 140 would not occupy most space of the body 122. Consequently, it can increase a probability that light of the illuminant module passes through the light-transmitting region 122a and provide a better visual effect.

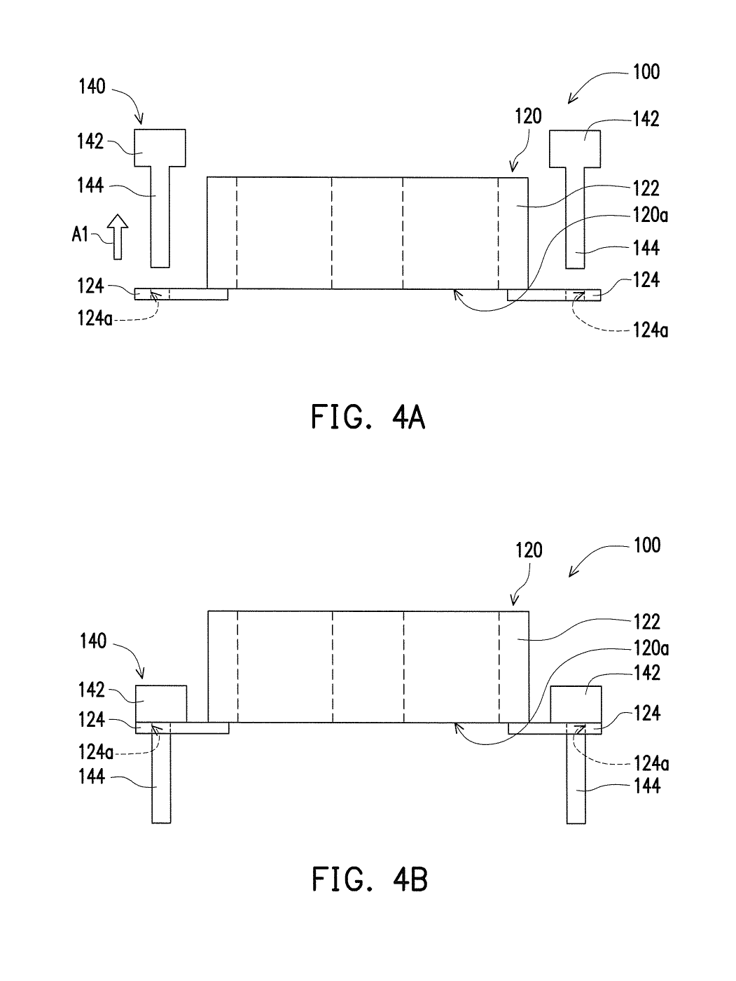

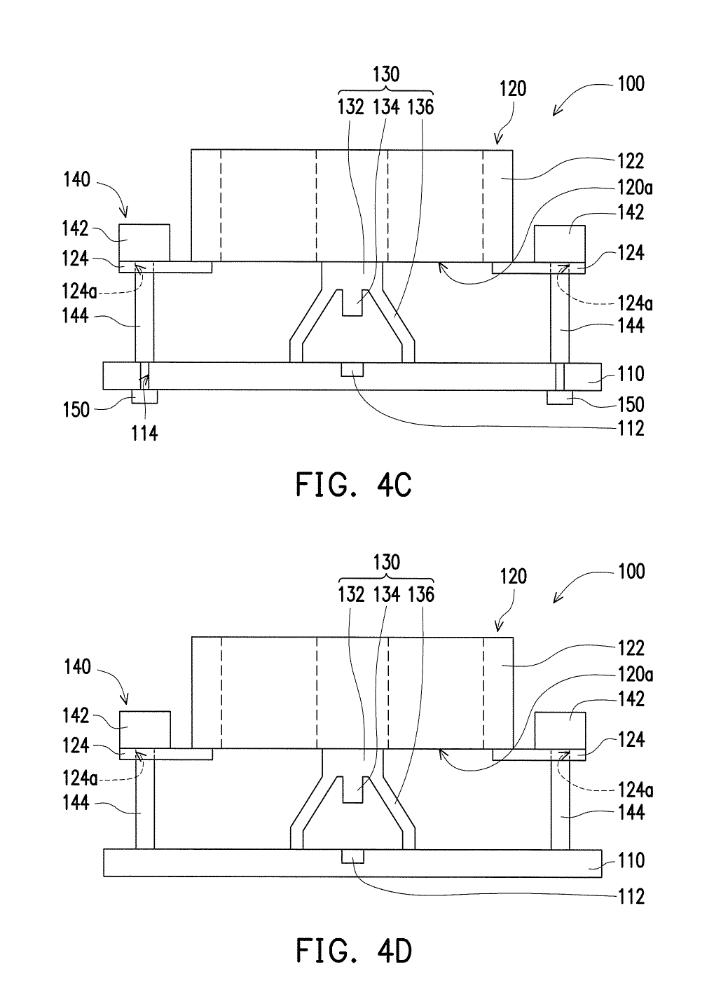

The manufacture and assembling process of the key structure 100 are illustrated hereinafter. FIG. 4A to FIG. 4D are flow charts showing a fabrication of a key structure shown in FIG. 1.

Please refer to FIG. 4A, a positioning unit 140 and a keycap 120 are provided. Detailedly speaking, the positioning unit 140 includes two positioning portions 142 which include four positioning pillars 144. The keycap 120 includes a body 122 and two side portions 124. Similarly, only two positioning pillars 144 are shown.

Then, please refer to FIG. 4B, the keycap 120 is assembled with the positioning unit 140. Detailedly speaking, two side portions 124 are located around the body 122 and the side portions 124 include a plurality of fixing portions 124a. Then, the positioning unit 140 is placed sequentially, that is the positioning portions 142 of the positioning unit 140 shown in FIG. 4A contact a surface or a desktop and the keycap 120 is assembled with the positioning unit 140 along the assembling direction A1 shown in FIG. 4A. The positioning pillars 144 pass through the fixing portions 124a to make the keycap 120 assemble with the positioning unit 140 as shown in FIG. 4B.

Finally, please refer to FIG. 4C, an elastic element 130 and a bottom portion 110 are provided, wherein the elastic element 130 is assembled with the bottom portion 110. The positioning unit 140 is assembled with the bottom portion 110 to finish the assembling process of the key structure 100.

Detailedly speaking, the key structure 100 further includes a locking portion 150. The positioning unit 140 is assembled with the bottom portion 110 by the locking portion 150. The bottom portion 100 includes a screw lock hole 114. The locking portion 150 passes through the corresponding screw lock hole 114 to make the bottom portion 110 and the positioning unit 140 lock together. In other embodiments, referring to FIG. 4D, the positioning unit 140 is fixed on the bottom portion 110 in a fusing way, which is not limited herein.

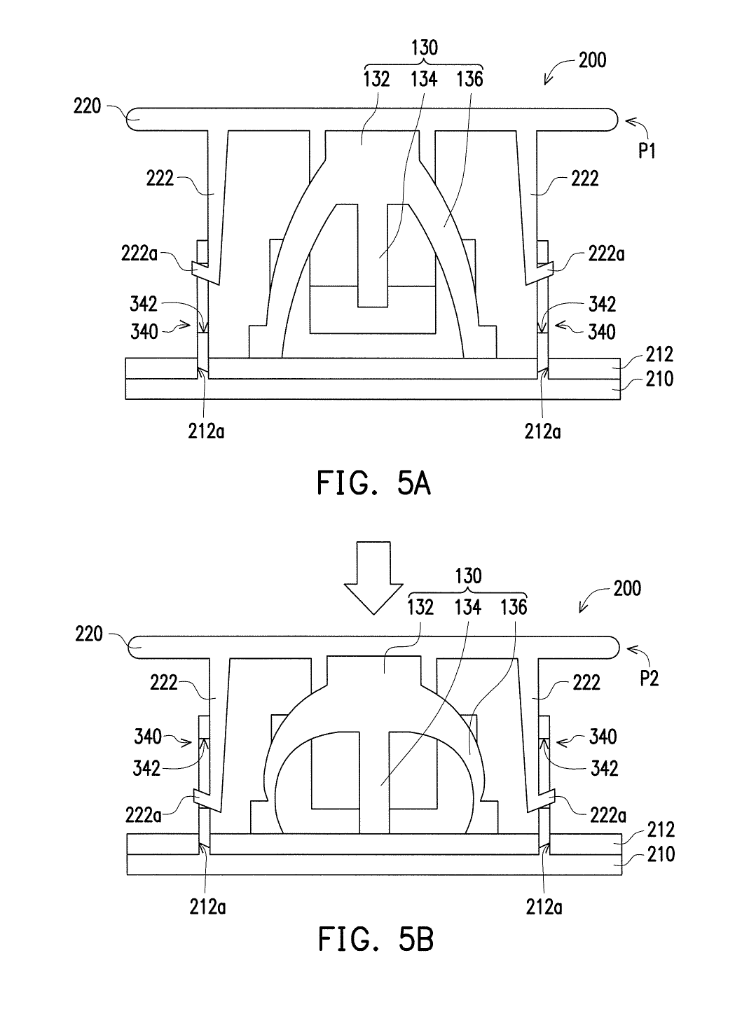

FIG. 5A is a side view showing a key structure before pressed in a second embodiment. FIG. 5B is a side view showing a key structure after pressed in a second embodiment. Please refer to FIG. 5A and FIG. 5B, the function and the shape of the elastic element 130 shown in FIG. 5A and FIG. 5B are same or similar to those of the elastic element 130 shown in FIG. 1, FIG. 2A and FIG. 2B, which is not illustrated again for a concise purpose.

The difference between a key structure 200 in this embodiment and the key structure 100 in FIG. 1 and FIG. 3 is that, in FIG. 5A and FIG. 5B, a fixing portion 222 of a keycap 220 includes a hook 222a, and a positioning unit 340 includes a plurality of sliding runners 342. The key structure 200 further includes a press unit 212, such as a membrane switch or other trigger switches. Additionally, unlike that the positioning unit 340 and the bottom portion 210 are assembled together in FIG. 1, the positioning unit 340 is integrally formed with a bottom portion 210 in this embodiment. Consequently, the positioning unit 340 passes through a hole 212a of the press unit 212 to make the press unit 212 assembled on bottom portion 210. Then, the elastic element 130 is assembled with the press unit 212. Finally, the hook 222a of the keycap 220 is assembled with the sliding runner 342 of the positioning unit 340 to make the keycap 220 and the positioning unit 340 assembled together. Thus, the assembling process of the key structure 200 is finished.

In this configuration, in the key structure 200, each hook 222a moves in the corresponding sliding runner 342 to make the keycap 220 move relative to the bottom portion 210. When the keycap 220 is pressed to make the keycap 200 move from the original position P1 as shown in FIG. 5A to the contact position P2 as shown in FIG. 5B, the hook 222a moves in the corresponding sliding runner 342, and the keycap 220 moves along the sliding runner 342 towards the bottom portion 210 without deviation, and the elastic element 130 is deformed and contacts the bottom portion 210 to trigger the key structure 200. On the contrary, when an external force pressing the keycap 220 is released, the keycap 220 moves from the contact position P2 as shown in FIG. 5B to the original position P1 as shown in FIG. 5A via the elastic force of the elastic element 130. The hook 222a moves in the corresponding sliding runner 342 and the keycap 220 still moves along the positioning unit 340 without deviation. Thus, the key structure is smooth and stable in the vertically moving process.

As stated above, in the key structure of the embodiments of the invention, a fixing portion is assembled with a positioning unit, and a keycap moves relative to a bottom portion via the positioning unit. When the keycap is pressed to make the keycap move towards the bottom portion, the keycap moves along the positioning unit towards the bottom portion without deviation. On the contrary, when an external force pressing the keycap is released, the keycap moves away from the bottom portion via the elastic force of an elastic element, and the keycap still moves along the positioning unit without deviation. Thus, the key structure is smooth and stable in the vertically moving process via the positioning unit cooperating with the elastic element.

Additionally, the positioning unit in this embodiment is configured around the keycap, that is, the positioning unit is not configured between the body and the bottom portion, the positioning unit does not need to take up most volume of the body, and thus the light of the illuminant module passes through the light-transmitting area is seldom blocked, and the visual effect is better.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A key structure, comprising:
a bottom portion;
a keycap including a plurality of fixing portions;
an elastic element configured between the bottom portion and the keycap; and
a positioning unit fixed on the bottom portion and assembled with the fixing portions, wherein the keycap moves relative to the bottom portion via the positioning unit.

2. The key structure according to claim 1, wherein the keycap includes a body and a plurality of side portions, the side portions are located around the body, and the fixing portions are located at the side portions respectively, the positioning unit includes a plurality of positioning portions, and the positioning portions are corresponding to the fixing portions, respectively.

3. The key structure according to claim 2, wherein when the keycap moves relative to the bottom portion, the distance between each of the side portions and the bottom portion is equal.

4. The key structure according to claim 2, wherein each positioning portion includes a positioning pillar, and the positioning pillars pass through the fixing portions to make the side portions move along the positioning pillars relative to the bottom portion.

5. The key structure according to claim 2, wherein the body includes a light transmitting area at an upper surface or a side surface of the keycap.

6. The key structure according to claim 1, wherein each fixing portion includes a hook, and the positioning unit includes a plurality of sliding runners, the hooks move in the sliding runners to make the keycap move relative to the bottom portion.

7. The key structure according to claim 1, wherein the elastics element includes a connecting portion, a conducting portion and a pair of support legs, the connecting portion is connected to a back surface of the keycap, the conducting potion is located between the support legs, when the keycap moves relative to the bottom portion, the connecting portion moves towards the bottom portion to make the support legs pressed and deformed, and make the conducting portion contact the bottom portion.

8. The key structure according to claim 7, wherein the bottom portion includes a press unit, the conducting portion is configured on the back surface of the keycap corresponding to the press unit, when the keycap moves relative to the bottom portion, the conducting portion contacts the press unit.

9. The key structure according to claim 1, further including:
a locking portion used for assembling the positioning unit and the bottom portion together.

10. The key structure according to claim 1, wherein the positioning unit is fixed on the bottom portion in a fusing way.

11. The key structure according to claim 1, wherein the positioning unit is integrally formed with the bottom portion.
